(19) United States
(12) Patent Application Publication
(10) Pub. No.: US 2007/0275217 A1
(43) Pub. Date: Nov. 29, 2007

(54) Pressure Sensitive Record Material

(76) Inventors: Richard David Saunders, Berkshire (GB); John Brian Cooper, Hants (GB)

Correspondence Address: BINGHAM MCCUTCHEN LLP, Three Embarcadero Center, San Francisco, CA, 94111-4067, US

(21) Appl. No.: 10/576,728

(22) PCT Filed: Oct. 22, 2004
(86) PCT No.: PCT/GB04/04473

§ 371 Date: Mar. 5, 2007

(30) Foreign Application Priority Data
Oct. 23, 2003 (GB) 0324755.8

(51) Int. Cl. B41M 5/124

(52) U.S. Cl. 428/211.1; 427/150

(57) ABSTRACT

The invention describes a sheet product comprising a paper sheet having on its front a printable coating comprising a pigment and a binder, and on its back isolated droplets of colour former solution each confined within a pressure rupturable barrier, in which the paper sheet carrying said pigment/binder coating has a Bendtsen porosity in excess of 100 ml/min prior to the application of the droplets of colour former solution.

This invention relates to paper for carbonless copy paper sets and to copy paper sets made up using it.

Carbonless copy paper sets consist of a top sheet known as the CB (coated back) sheet, a back sheet known as the CF (coated front) sheet, and optionally one or more intermediate sheets known as CFB (coated front and back) sheets. The coatings of the back of the CB sheet, of the front and back of the CFB sheets if any, and of the front of the CF sheet contain materials that when brought into association with each other develop a coloured image. The sheets are generally bonded together by an edge padding adhesive.

When the front of the CB sheet is typed on or otherwise pressure imaged, material is transferred between the back of one sheet and the front of the next through the set to give rise to the copies required. Usually, a solution of a dye precursor or “colour former” carried on the sheet as isolated droplets each confined within a pressure rupturable barrier, is transferred from the back of one sheet to the front of the next after rupture of the barrier by the applied pressure, and interacts with a “colour developer” present there to give the image.

Electrophotographic printers, such as laser printers, use high temperatures to fuse the toner used for printing, and the paper used in these printers needs to satisfy a number of challenging criteria, for example good toner adhesion, image quality, dimensional stability and curl. For the HP/Indigo system the paper surface has to be compatible with the ink to give ink acceptance and adhesion. It is especially difficult to provide carbonless copy paper sets which meet all these criteria, and which in addition have satisfactory edge padding characteristics.

Conventionally, it has been believed that CB sheets should have a low porosity. Thus, for example, U.S. Pat. No. 4,912,080 describes pressure sensitive carbonless transfer sheets made from a base sheet which has a Gurley porosity of 400-4000 seconds. This porosity (which is equivalent to 30.8-3.1 ml/min if measured on the alternative Bendtsen scale) is very low.

EP 274886A describes an improved CB sheet, which comprises a paper sheet having on its front a printable pigment coating and on its back isolated droplets of colour former solution each confined within a pressure rupturable barrier, wherein the pigment coating comprises a binder for the pigment together with a specific synthetic reactive sizing agent or a specific coating structure agent or both. Preferably, in order to reduce curl during the coating process used in the manufacture of the coated product of the invention of EP 274886A, the Bendtsen porosity of the finished CB coated sheet is not less than 25 ml/min, preferably not less than 30 ml/min, with a typical range of 35-50 ml/min. Such porosities reflect porosities before CB coating of around 30 ml/min. or more allowing economic application of the CB coating.

In use, the CB sheet described in EP 274886A gives good performance when used in litho printers, but not in laser printers: although good toner adhesion, image quality, edge padding, and HP/Indigo ink acceptance and adhesion are achieved, excessive curl of the paper occurs after fusing.

We have now found that, surprisingly, a high porosity before CB coating is required to produce acceptable curl in comparison to standard coated grades used for electrophotographic printing. The use of a topcoat which gives a sheet having a Bendtsen porosity of greater than 100 ml/min prior to CB conversion results in a sheet which does not curl when used in electrophotographic printers.

Accordingly, the present invention provides a sheet product comprising a paper sheet having on its front a printable coating comprising a pigment and a binder, and on its back isolated droplets of colour former solution each confined within a pressure rupturable barrier, characterised in that the paper sheet carrying said pigment/binder coating has a Bendtsen porosity in excess of 100 ml/min, preferably in excess of 120 ml/min, prior to the application of the droplets of colour former solution.

The invention also provides a carbonless copy paper set which includes at least a CB sheet and a CF sheet, in which the CB sheet is a sheet product according to the invention.

The invention further provides the use of a coating comprising a pigment and a binder and having characteristics such that when used in a sheet product as a coating on the front of a paper sheet having on its back isolated droplets of colour former solution each confined within a pressure rupturable barrier, the paper sheet product carrying said pigment/binder coating has a Bendtsen porosity in excess of 100 ml/min, preferably in excess of 120 ml/min, prior to the application of the droplets of colour former solution; said use being to reduce curl following printing of the sheet product using an electrophotographic printer.

The composition of the pigment/binder layer is the main factor determining the Bendtsen porosity of the sheet product according to the invention. Bendtsen porosity should be understood to be the porosity of the sheet product when measured by ISO test method number ISO 5636 (part 3).

Preferably the pigment/binder coating includes a synthetic reactive sizing agent or a coating structure agent or both, the sizing agent preferably being an alkyl ketene dimer, alkenyl succinic anhydride, polyurethane, or other synthetic reactive size, and the coating structure agent preferably being a carboxy methyl cellulose, a soya or other protein, an alginate, or other hydrophilic polymer. The relative amounts of components in the coating are desirably by weight 0.5-10 parts (advantageously 0.5 or 1 up to 5 parts) size and 0.5-5 parts) size and 0.5-5 parts coating structure agent, together with 60-95 parts pigment and 5-30 parts preferably 10-30 parts and advantageously 16-22 parts binder or, where the coating structure agent is present without size, 75-82 parts (less desirably up to 85 parts) pigment, and 15-22 parts (less desirably down to 12 parts) binder.

The pigment used is, generally, a conventional paper coating pigment, in particular an inorganic or mineral-derived particulate material. Mixture of pigments may be used. Calcium carbonate especially is economic and suitable, giving good whiteness and purity and having good printing characteristics, and either ground calcium carbonate or precipitated calcium carbonate or a mixture may be used. Other suitable pigments, which may be used alone or in admixture with calcium carbonate, include coating clays such as china clay (kaolin), calcined clays, titanium dioxide, finely divided silica, and talc. Small quantities, for example up to 10%, of specialist pigments, for example T₁O₂ whitener, may be included if desired.

The use of a mixture of ground calcium carbonate and precipitated calcium carbonate as pigment is especially preferred because this provides the best combination for coating structure necessary to yield the desired porosity characteristics.

The particle size of the pigment is selected in order to provide the desired porosity of the sheet product, and is preferably in the range of from 1 to 10 microns, especially 1 to 5 microns. Ground calcium carbonate in which up to 70% of the particles, preferably up to 60% of the particles, have a particle size of less than 2 microns, optionally in admixture with precipitated calcium carbonate, is preferred.

Particle sizes are as measured by a laser particle sizer such as the standard Malvern 3600 E Type. For particles of broadly the same dimensions in any direction, such as those of calcium carbonate, such sizes approximate actual sizes; for flat or elongated particles such as those of coating clays the particle sizes as measured are nominal. The laser instrument assesses particle size by measuring the interference pattern arising from diffraction of the laser light illuminating a sample suspension e.g. in water of the particles. The pattern is manipulated by a computer to vie results as particle size by volume, e.g. the volume itself or the diameter of spheres of equal volume.

The binder may be selected from among those conventional in themselves in paper coating technology. In particular it may be synthetic rubber latex such as styrene butadiene latex (normally a carboxylated grade to give good dispersibility and stability in water) or styrene acrylic latex. It is also however possible for it to be example an ether derivative of starch.

The size, if present, will typically be a neutral reactive size such as an alkyl ketene dimer or alkenyl succinic anhydride with the alkyl or alkenyl groups from C₈ upwards, generally from C₁₂ upwards, with C₁₅-C₁₈ typical and the upper limit determined, for example at C₂₄, by mix workability and suitability of the final coating for printing. Such sizes, in which “neutral” connotes effectiveness as sizes at neutral coating mix pH, are effective in small quantities and readily provide acceptable rheology in the coating process, for example blade, roll or slot (extrusion) coating. Other synthetic sizes such as polyurethane sizes may however be used. Amounts within the ranges given earlier are typically 1 to 5% dry weight of the coating but more usually 1 to 2% will be used.

Coating structure agents which may be used if desired include in particular carboxy methyl cellulose such as is used in coating technology as a dewatering control. Other suitable materials are proteins, such as soya protein, and alginates such as sodium alginate. The optimal amount used depends on the nature of the material—enough to be effective but not so much as to increase viscosity or modify the rheology to make the mix uncoatable. Preferred amounts are typically, weight % on coating:

Carboxy methyl cellulose

| | |
|---|---|
| High mol. wt | 0.5-1.5% |
| Medium mol. wt | 1-2% |
| Low mol. wt | 2-3% |
| Sodium alginate | 0.7-1.5% |
| Soya protein | 1.5-4% |

Other known agents may also be present in the mix if desired, for example sodium hydroxide or other alkalis such as potassium hydroxide or ammonia for pH adjustment, optical brightening agents, dispersants for the pigment(s), lubricants (e.g. calcium stearate) or antifoams.

Adjustment of the coat weight of the pigment/binder topcoat is important in order to obtain the required porosity. The coat weight may conveniently be from 2 to 10 g/m², advantageously 3 to 8 g/m².

The solids content of the coating mix is preferably from 25-75% solids, especially 30-70%, advantageously 50-65%.

The following Example illustrates the invention.

### EXAMPLE

Top coated 90 g base paper was manufactured on a production paper and online blade coating machine. For the control a standard topcoat formulation was used and coated at approximately 7.5 gsm. For the trial a higher porosity mix formulation was used and coated at 5.5 gsm. These papers were then offline CB coated on the opposite side of the paper using a production roll coating machine to make a carbonless CB product. The trial and control CB were then converted to A4 sheets and tested for hanging curl by running though a Xerox Docutech (Trade Mark) printing system.

Details of the control and trial top coat mix formulations are given in Table 1.

TABLE 1

| | Dry Wt % | |
|---|---|---|
| Material | Control | Trial |
| Carbital C75 (ground calcium carbonate having 75% | 86.4 | |
| of particles with particle size less than 2 microns) | | |
| Carbital C60 (ground calcium carbonate having 60% | | 43.2 |
| of particles with particle size less than 2 microns) | | |
| PCC (precipitated calcium carbonate) | | 43.2 |
| CMC (carboxy methyl cellulose) | 0.9 | 0.9 |
| Latex | 12.7 | 12.7 |

The Bendtsen porosity of the product in the control experiment was 60 ml/min, while the porosity of the product according to the invention was 120 ml/min.

Post electrophotographic print hanging curl and print results after printing on a Xerox Docutech (Trade Mark) printing system were as follows:

Control: Post print hanging curl=>100 towards the CB side—caused many jams and turned corners in the machine

Trial: Post print hanging curl=50 towards the CB side—ran without jams or turned corners.

1. A sheet product comprising a paper sheet having on its front a printable coating comprising a pigment and a binder, and on its back isolated droplets of colour former solution each confined within a pressure rupturable barrier, characterised in that the paper sheet carrying said pigment/binder coating has a Bendtsen porosity in excess of 100 ml/min prior to the application of the droplets of colour former solution.

2. A sheet product according to claim 1, characterised in that the paper sheet carrying said pigment/binder coating has a Bendtsen porosity in excess of 120 ml/min prior to the application of the droplets of colour former solution.

3. A sheet product according to claim 1, in which the pigment/binder coating includes a synthetic reactive sizing agent or a coating structure agent or both.

4. A sheet product according to claim 3, the sizing agent being an alkyl ketene dimer, alkenyl succinic anhydride, or a polyurethane, and the coating structure agent being a carboxy methyl cellulose, a protein, or an alginate.

5. A sheet product according to claim 3, in which the size if present is present in the pigment/binder coating in an amount of from 0.5-10 parts by weight, and the coating structure agent if present is present in the pigment/binder layer in an amount of from 0.5-5 parts by weight.

6. A sheet product according to claim 3, which contains carboxy methyl cellulose.

7. A sheet product according to claim 1, in which the pigment is selected from calcium carbonate, china clay (kaolin), calcined clays, titanium dioxide, finely divided silica, talc, and mixtures thereof.

8. A sheet product according to claim 7, in which the pigment is calcium carbonate.

9. A sheet product according to claim 1, in which the particle size of the pigment is in the range of from 1 to 10 microns.

10. A sheet product according to claim 1, in which the binder is a synthetic rubber latex, a styrene acrylic latex, or an ether derivative of starch.

11. A sheet product according to claim 1, in which the coat weight of the pigment/binder layer is in the range of from 2 to 10 g/m².

12. A carbonless copy paper set which includes at least a CB sheet and a CF sheet, in which the CB sheet is a sheet product as claimed in claim 1.

13. The use of a coating comprising a pigment and a binder and having characteristics such that when used in a sheet product as a coating on the front of a paper sheet having on its back isolated droplets of colour former solution each confined within a pressure rupturable barrier, the paper sheet product carrying said pigment/binder coating has a Bendtsen porosity in excess of 100 ml/min prior to the application of the droplets of colour former solution; said use being to reduce curl following printing of the sheet product using an electrophotographic printer.

14. The use according to claim 13, in which the pigment/binder coating has the characteristics of any one of claims 1 to 11.
